(19) United States
(12) Patent Application Publication
(10) Pub. No.: US 2011/0112856 A1
(43) Pub. Date: May 12, 2011

(54) MEDICAL IMAGING PROCEDURES AND METHOD AND SYSTEM FOR MANAGING MEDICAL IMAGING PROCEDURES

(75) Inventors: Benny Rousso, Rishon-LeZion (IL); Yoel Zilberstein, Herzlia (IL); Haim Melman, Kfar-Saba (IL); Shlomo Ben-Haim, Orangeburg, NY (US)

(73) Assignee: Spectrum Dynamics LLC, Orangeburg, NY (US)

(21) Appl. No.: 13/003,318

(22) PCT Filed: Jul. 13, 2009
(86) PCT No.: PCT/IB09/53035

§ 371 Date: Jan. 10, 2011

(51) Int. Cl. G06Q 50/00; G06Q 10/00

(52) U.S. Cl. 705/2

(57) ABSTRACT

A method for managing a plurality of medical imaging procedures. The method comprises associating a machine readable tag with each of a plurality of patients designated for a plurality of medical imaging procedures, monitoring a progress of at least one of the plurality of patients in a respective the medical imaging procedure, and managing at least one medical imaging resource for performing the plurality of medical imaging procedures according to the progress.

### FIELD AND BACKGROUND OF THE INVENTION

The present invention, in some embodiments thereof, relates to method and apparatus for procedures and, more particularly, but not exclusively to method and apparatus for managing medical examination sessions.

Radionuclide imaging aims at obtaining an image of a radioactively labeled substance, that is, a radiopharmaceutical, within the body, following administration, generally, by injection. The substance is chosen so as to be picked up by active pathologies to a different extent from the amount picked up by the surrounding, healthy tissue in consequence; the pathologies are operative as radioactive-emission sources and may be detected by radioactive-emission imaging. Pathology may appear as a concentrated source of high radiation, that is, a hot region, as may be associated with a tumor, or as a region of low-level radiation, which is nonetheless above the background level, as may be associated with carcinoma.

A reversed situation is similarly possible. Dead tissue has practically no pick up of radiopharmaceuticals, and is thus operative as a cold region.

The mechanism of localization of a radiopharmaceutical in a particular organ of interest depends on various processes in the organ of interest such as antigen-antibody reactions, physical trapping of particles, receptor site binding, removal of intentionally damaged cells from circulation, and transport of a chemical species across a cell membrane and into the cell by a normally operative metabolic process. A summary of the mechanisms of localization by radiopharmaceuticals is found in www.lunis.luc.edu/nucmed/tutorial/radpharm/i.htm.

During the last years, systems and methods for managing patients in clinical centers have been developed. For example U.S. Patent Application Publication Number 2008/0262867 filed on May 1, 2007 described a method of patient management that may include receiving appointment data regarding an appointment for a patient with a selected clinician at a predetermined time, inserting an appointment entry on an electronic calendar of the selected clinician, attaching patient data to the appointment entry on the electronic calendar, providing a first electronic link on the appointment entry to medical records of the patient, providing a second electronic link on the appointment entry to a map showing an address of the patient, partially pre-filling a patient visit form using the attached patient data, receiving patient visit data electronically entered by the selected clinician on the patient visit form during the appointment, and storing the patient visit data into a patient database.

Such management methods are particularly important in radionuclide in which the preparation of radiopharmaceutical preparations has to be adjusted to the patient and/or the pathology and has to take into account the active period of the radiopharmaceutical preparations. The particular choice of a radionuclide for labeling antibodies depends upon the chemistry of the labeling procedure and the isotope nuclear properties, such as the number of gamma rays emitted, their respective energies, the emission of other particles such as beta or positrons, the isotope half-life, and the decay scheme.

In PET imaging, positron-emitting radioisotopes are used for labeling, and the imaging camera detects coincidence photons, the gamma pair of 0.511 Mev, traveling in opposite directions. Each one of the coincident detections defines a line of sight, along which annihilation takes place. As such, PET imaging collects emission events, which occurred in an imaginary tubular section enclosed by the PET detectors. A gold standard for PET imaging is PET NH₃ rest myocardial perfusion imaging with N-13-ammonia (NH₃), at a dose level of 740 MBq, with attenuation correction. Yet, since the annihilation gamma is of 0.511 Mev, regardless of the radioisotope, PET imaging does not provide spectral information, and does not differentiate between radioisotopes.

In SPECT imaging, primarily gamma emitting radioisotopes are used for labeling, and the imaging camera is designed to detect the actual gamma emission, generally, in an energy range of approximately 11-511 KeV. Generally, each detecting unit, which represents a single image pixel, has a collimator that defines the solid angle from which radioactive emission events may be detected.

Because PET imaging collects emission events, in the imaginary tubular section enclosed by the PET detectors, while SPECT imaging is limited to the solid collection angles defined by the collimators, generally, PET imaging has a higher sensitivity and spatial resolution than does SPECT. Therefore, the gold standard for spatial and time resolutions in nuclear imaging is defined for PET. For example, there is a gold standard for PET imaging for at rest myocardial perfusion with N-13-ammonia (NH₃), at a dose of 740 MBq with attenuation correction.”

Conventional SPECT cameras generally employ an Anger camera, in which a single-pixel scintillation detector, such as NaI(Tl), LSO, GSO, CsI, CaF, or the like, is associated with a plurality of photomultipliers. Dedicated algorithms provide a two dimensional image of the scintillations in the single pixel scintillation detector. There are several disadvantages to this system, for example:

1. The dedicated algorithms associated with the single pixel cannot reach the accuracy of a two-dimensional image of a plurality of single pixel detectors;
2. The single-pixel detector is a rigid unit, which does not have the flexibility of motion of a plurality of small detectors, each with independent motion; and
3. A single hot spot may cause the single pixel detector of the Anger camera to saturate, whereas when a plurality of single pixel detectors is employed, saturation is localized to a few pixels and does not affect the whole image.

Other SPECT cameras which employ a plurality of single pixel detectors are also known.

### SUMMARY OF THE INVENTION

According to some embodiments of the present invention there is provided a method for managing a plurality of medical imaging procedures. The method comprises

associating a machine readable tag with each of a plurality of patients designated for a plurality of medical imaging procedures;

monitoring a progress of at least one of the plurality of patients in a respective the medical imaging procedure; and

managing at least one medical imaging resource for performing the plurality of medical imaging procedures according to the progress.

Optionally, the managing comprises adjusting an imaging scanning pattern according to the progress.

Optionally, the plurality of medical imaging procedures are nuclear medical imaging procedures, the monitoring comprises monitoring an order of a radiopharmaceutical preparation (RP) of at least one radioactive isotope and the managing being performed according to the at least one radioactive isotope.

More optionally, the method further comprises receiving medical information pertaining to each the patient and providing an estimation of the decay profile of the at least one radioactive isotope in a respective the patient according to respective the medical information, the managing being performed according to the estimation. According to some embodiments of the present invention there is provided a system for monitoring a plurality of imaged patients. The system comprises a resource interface for receiving a status data from at least one medical imaging resource each used in one of a plurality of stages of a imaging procedure, a patient interface for automatically interfacing with a plurality of medical imaging procedure tags associated with a plurality of patients so as to receive, from each the medical imaging procedure tag, data indicative of the stage of the plurality of stages in which a respective the patient being in, and a processing unit for allocating the at least one medical imaging resource to the plurality of patients according to the data.

Optionally, the processing unit is configured for monitoring a progress of the plurality of patients along the plurality of stages according to the data and generating an alert according to the progress.

More optionally, the system further comprises a communication unit for forwarding the alert to at least one of the plurality of medical imaging procedure tags.

Optionally, the imaging procedure is a nuclear medical imaging procedure and one of the plurality of stages is a radiopharmaceutical preparation (RP) injection having a decay profile, the processing unit being configured to for timing the allocation according to the decay profile.

According to some embodiments of the present invention there is provided a method for reporting a progress of a plurality of medical imaging procedures. The method comprises associating a machine readable tag with each of a plurality of patients designated for a plurality of medical imaging procedures, automatically monitoring a progress of at least one of the plurality of patients in a respective the medical imaging procedure, and outputting a report indicative of the progress.

Optionally, the method comprises associating a machine readable tag with each of a plurality of radiopharmaceutical preparation (RP) containers designated for the plurality of medical imaging tagged procedures, the monitoring is performed according so a geographic location of the plurality of RP containers.

Optionally, the outputting comprises forwarding the report as an alert to a system operator.

According to some embodiments of the present invention there is provided a method for preparing at least one pharmaceutical preparation. The method comprises setting a scheduling for a nuclear medicine imaging process of a patient at a clinical center, establishing a connection between the clinical center and at least one pharmacy, and sending the scheduling and medical information pertaining to the patient to at least one pharmacy via the connection. The sending allows the at least one pharmacy to generate a pharmaceutical preparation for the nuclear medicine imaging process according to the medical information and the scheduling.

Optionally, the sending comprises updating at least one of the scheduling and the medical information, the pharmaceutical preparation being generated according to the updating.

Optionally, the sending comprises sending pricing information so as to allow the at least one pharmacy to prepare the pharmaceutical preparation according to the pricing information.

Optionally, the pharmaceutical preparation comprises a mixture of a plurality of isotopic tracers, wherein a ratio between the plurality of isotopic tracers is determined according to at least one of the scheduling and the medical information.

Optionally, the method further comprises receiving, via the connection, a notification indicative of at least one of a decline to generate the pharmaceutical preparation and a confirmation for a generation of the pharmaceutical preparation.

Optionally, the method further comprises receiving, at the clinical center, the pharmaceutical preparation and monitoring a usage of the pharmaceutical preparation according to the scheduling.

According to some embodiments of the present invention there is provided a method for preparing at least one radiopharmaceutical preparation. The method comprises providing a radiopharmaceutical preparation (RP) having at least one radioactive isotope for a nuclear medicine imaging process for a patient, providing medical information related to the patient, automatically calculating a concentration-time profile of the RP in the patient according to the medical information and the at least one radioactive isotope, and automatically scheduling an allocation of at least one medical imaging resource for performing at least one stage of the nuclear medicine imaging process according to the concentration-time profile.

Optionally, the method further comprises adjusting at least one imaging session of the medical imaging resource according to the concentration-time profile.

Optionally, the providing comprises providing a plurality of RPs for a plurality of medical imaging acquisition sessions performed during the nuclear medicine imaging process, the calculating and the scheduling being performed for each the RP.

According to some embodiments of the present invention there is provided a radiopharmaceutical preparation for lung cancer diagnosis. The radiopharmaceutical preparation comprises at least one dose consisting of at least two of the following components: Sestamibi Tc^{99m}, Tl201, Teboroxime Tc^{99m}, Thymidine I¹²³, and PK-11195 and at least one of I¹²³ and In¹¹¹.

Optionally, the at least one dose comprises at least three of the components.

Optionally, the at least one dose comprises a plurality of doses each having a different of the components.

More optionally, the radiopharmaceutical preparation further comprises a plurality of containers each configured for separately storing one of the plurality of doses.

Optionally, the at least two components further comprises a member from a group consisting of a contrast agent, a stress agent and a pharmaceutical modulating at least one target tissue property.

Optionally, the at least one dose comprises a single dose having the at least two components.

Optionally, the ratio between the quantities of the at least two components is determined according to medical information pertaining to an administered patient.

According to some embodiments of the present invention there is provided a radiopharmaceutical preparation for colorectal cancer diagnosis. The radiopharmaceutical preparation comprises at least one dose consisting of at least two of the following components: Sestamibi Tc^{99m}, Arcitumomab carcinoembryonic antigen (CEA) Tc^{99m}, Tl201, Teboroxime Tc^{99m}, Avastin In¹¹¹, Thymidine I¹²³, and PK-11195 and at least one of I¹²³ and In¹¹¹.

Optionally, the at least one dose comprises at least three of the components.

Optionally, the at least one dose comprises all of the components.

Optionally, the at least one dose comprises a plurality of doses each having a different of the components.

More optionally, the radiopharmaceutical preparation further comprises a plurality of containers each configured for separately storing one of the plurality of doses.

Optionally, the at least two components further comprises a member from a group consisting of a contrast agent, a stress agent and a pharmaceutical modulating at least one target tissue property.

Optionally, the at least one dose comprises a single dose having the at least two components.

Optionally, the ratio between the quantities of the at least two components is determined according to medical information pertaining to an administered patient.

According to some embodiments of the present invention there is provided a radiopharmaceutical preparation breast cancer diagnosis. The radiopharmaceutical preparation comprises at least one dose consisting of at least two of the following components: Sestamibi Tc^{99m}, Tl201, Teboroxime Tc^{99m}, Herceptin I¹²³, and PK-11195 and at least one of I¹²³ and In¹¹¹.

Optionally, the at least one dose comprises at least three of the components.

Optionally, the at least one dose comprises all of the components.

Optionally, the at least one dose comprises a plurality of doses each having a different of the components.

More optionally, the radiopharmaceutical preparation further comprises a plurality of containers each configured for separately storing one of the plurality of doses.

Optionally, the at least two components further comprises a member from a group consisting of a contrast agent, a stress agent and a pharmaceutical modulating at least one target tissue property.

Optionally, the at least one dose comprises a single dose having the at least two components.

Optionally, the ratio between the quantities of the at least two components is determined according to medical information pertaining to an administered patient.

According to some embodiments of the present invention there is provided a radiopharmaceutical preparation for prostatic adenocarcinoma diagnosis. The radiopharmaceutical preparation comprises at least one dose consisting of the following components: Sestamibi Tc^{99m} and J-591 labeled with In¹¹¹.

Optionally, the at least one dose comprises at least three of the components.

Optionally, the at least one dose comprises all of the components.

Optionally, the at least one dose comprises a plurality of doses each having a different of the components.

More optionally, the radiopharmaceutical preparation further comprises a plurality of containers each configured for separately storing one of the plurality of doses.

Optionally, the components further comprises a member from a group consisting of a contrast agent, a stress agent and a pharmaceutical modulating at least one target tissue property.

Optionally, the at least one dose comprises a single dose having the components.

Optionally, the ratio between the quantities of the components is determined according to medical information pertaining to an administered patient.

According to some embodiments of the present invention there is provided a radiopharmaceutical preparation for Lymphoma diagnosis. The radiopharmaceutical preparation comprises at least one dose consisting of at least two of the following components: Rituxan+In¹¹¹, Thymidine I¹²³, Ga⁶⁷, Sestamibi Tc^{99m}, and Teboroxime Tc^{99m}.

Optionally, the at least one dose comprises at least three of the components.

Optionally, the at least one dose comprises all of the components.

Optionally, the at least one dose comprises a plurality of doses each having a different of the components.

More optionally, the radiopharmaceutical preparation further comprises a plurality of containers each configured for separately storing one of the plurality of doses.

Optionally, the at least two components further comprises a member from a group consisting of a contrast agent, a stress agent and a pharmaceutical modulating at least one target tissue property.

Optionally, the at least one dose comprises a single dose having the at least two components.

Optionally, the ratio between the quantities of the at least two components is determined according to medical information pertaining to an administered patient.

According to some embodiments of the present invention there is provided a radiopharmaceutical preparation for diagnosis. The radiopharmaceutical preparation comprises at least one dose consisting of Thallium 201 and Sestamibi Tc^{99m} in a ratio of about 1:3.5.

According to some embodiments of the present invention there is provided a radiopharmaceutical preparation for diagnosis. The radiopharmaceutical preparation comprises at least one dose consisting of Thallium 201 and Sestamibi Tc^{99m} in a ratio of about 1:3.

According to some embodiments of the present invention there is provided a method for generating an image for colorectal cancer diagnosis. The method comprises preparing a radiopharmaceutical preparation having at least one dose consisting of at least two of the following components, Sestamibi Tc^{99m} for marking tumor activity, Arcitumomab carcinoembryonic antigen (CEA) Scan Tc^{99m}, Tl201 for marking blood flow, Teboroxime Tc^{99m}, Avastin In¹¹¹, Thymidine I¹²³, and PK-11195 and at least one of I¹²³ and/or In¹¹¹, administering the at least one dose to a patient; and simultaneously imaging at least one of an intake and a concentration of the at least two components in a target organ in the patient.

According to some embodiments of the present invention there is provided a method for generating an image for lung cancer diagnosis. The method comprises preparing a radiopharmaceutical preparation having at least one dose consisting of at least two of the following components: Sestamibi Tc^{99m}, Tl201, Teboroxime Tc^{99m}, Thymidine I¹²³, and PK-11195 and at least one and I¹²³ and/or In¹¹¹, administering the at least one dose to a patient, and simultaneously imaging at least one of an intake and a concentration of the at least two components in a target organ in the patient.

According to some embodiments of the present invention there is provided a method for generating an image for breast cancer diagnosis. The method comprises preparing a radiopharmaceutical preparation having at least one dose consisting of at least two of the following components: Sestamibi Tc99m, Tl201, Teboroxime Tc99m, Herceptin I123, and PK-11195 and at least one of I¹²³ and In¹¹¹, administering the at least one dose to a patient, and simultaneously imaging at least one of an intake and a concentration of the at least two components in a target organ in the patient.

According to some embodiments of the present invention there is provided a method for generating an image for prostatic adenocarcinoma diagnosis. The method comprises preparing a radiopharmaceutical preparation having at least one dose consisting of the following components: Sestamibi Tc^{99m} and J-591 labeled with In¹¹¹, administering the at least one dose to a patient, and simultaneously imaging at least one of an intake and a concentration of the components in a target organ in the patient.

According to some embodiments of the present invention there is provided a method for generating an image for prostatic Lymphoma diagnosis. The method comprises preparing a radiopharmaceutical preparation having at least one dose consisting of at least two of the following components Rituxan+In¹¹¹, Thymidine I123, Ga⁶⁷, Sestamibi Tc99m, and Teboroxime Tc99m, administering the at least one dose to a patient, and simultaneously imaging at least one of an intake and a concentration of the at least two components in a target organ in the patient.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for monitoring a plurality of medical imaging procedures, according to some embodiments of the present invention;

FIG. 2 is a schematic illustration of a system for plurality of medical imaging procedures, according to some embodiments of the present invention;

FIG. 3 is a schematic illustration of different types of data which are related to a radiopharmaceutical preparation and/or the designated patient, according to some embodiments of the present invention;

FIG. 4 is a schematic illustration of an exemplary process for monitoring a medical imaging procedure, according to some embodiments of the present invention;

FIG. 5 is an exemplary screenshot of a report that may be displayed on one of the client terminals and/or on a screen that is connected to the monitoring system, according to some embodiments of the present invention;

FIG. 6 is a flowchart of a method for preparing one or more patient dependent radiopharmaceutical preparations, according to some embodiments of the present invention;

FIG. 7 is a schematic illustration of a system for synchronizing between one or more clinical centers and one or more radiopharmacy centers, according to some embodiments of the present invention; and

FIG. 8 is a schematic illustration of an exemplary nuclear medicine imaging process of using a SPECT camera, according to some embodiments of the present invention.

### DESCRIPTION OF EMBODIMENTS OF THE INVENTION

The present invention, in some embodiments thereof, relates to a method and an apparatus for managing procedures and, more particularly, but not exclusively to a method and an apparatus for managing medical managing medical examination sessions.

According to some embodiments of the present invention, there is provided a method and a system for managing medical imaging procedures of a plurality of patients in one or more clinical centers. The method and system allow providing, in real time, data pertaining to the patients and resources which are used during the managing medical imaging procedures. In such a manner, the managing medical imaging procedures, the resources, and/or the patients, may be managed and/or adjusted in a manner that improves the efficacy and throughput of the clinical centers. Optionally, the method and the system allow adjusting the one or more radiopharmaceutical preparations which are used during the managing medical imaging procedures and/or managing the ordering process thereof. Optionally, the method and system allow dynamically adjusting the medical imaging procedures and/or the order thereof according to exceptions, malfunctions, and/or any other changes in the functionality and or availability of the resources and/or the urgency of performing the medical imaging procedures.

According to some embodiments of the present invention, there is provided a method for preparing one or more patient based radiopharmaceutical preparations for a medical procedure. The method is based on receiving medical information about the patient and data that is related to a medical imaging that is designated to the patient and defining, optionally automatically, one or more radiopharmaceutical preparations according to the medical information and the medical imaging data. The defining is optionally performed in a negotiation process between one or more radiopharmacy centers and the clinical center. The one or more defined radiopharmaceutical preparations are then used for a medical imaging process. Optionally, the medical imaging process is adjusted according to the medical information and/or the one or more defined radiopharmaceutical preparations.

According to some embodiments of the present invention, there is provided a system for allowing a clinical center to define one or more radiopharmaceutical preparations for a certain patient in one or more negotiation sessions with one or more radiopharmacy centers. Such a system synchronizes the different phases of the medical imaging by coordinating among the ordering of the medical imaging, the manufacturing of suitable radiopharmaceutical preparations, and optionally the capturing of the respective medical imaging signals from the injected organs of the patient.

In an exemplary embodiment of the invention there is provided a networked system including both radio-pharmaceutical generation and image planning, in which scheduling data, clinical data, cost data and/or manufacturing data are interacted to decide on a treatment to be carried out. Optionally, the treatment data and radio-pharmaceutical data are stored on or indicated by a marker associated with the radio-pharmaceutical dosage and which is optionally read by an imaging device and followed thereby. In an exemplary embodiment of the invention, the decision may be modified in real time as the situation changes, for example, schedule.

In an exemplary embodiment of the invention, various elements of the network can modify the parameters of the treatment/diagnosis, as they see fit, optionally within an allowed range.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

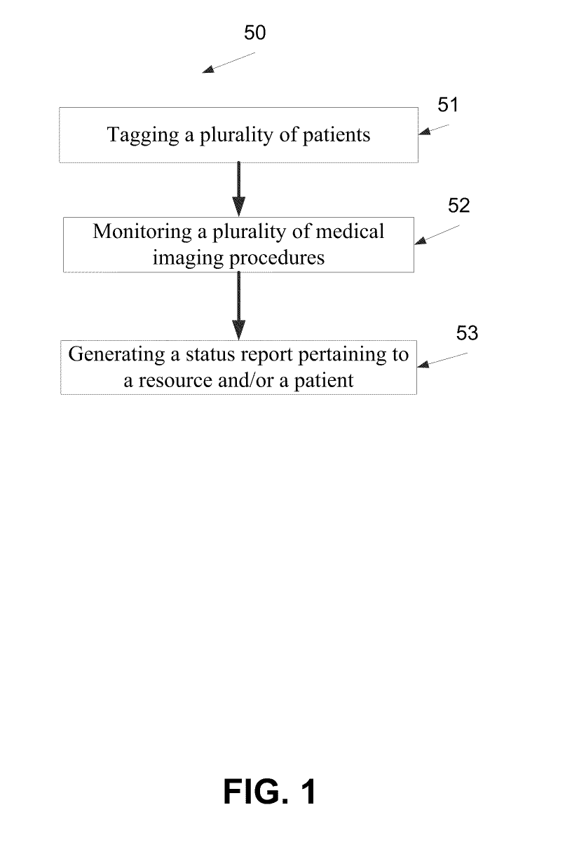

Reference is now made to FIG. 1, which is a flowchart 50 of a method for monitoring a plurality of medical imaging procedures, according to some embodiments of the present invention. First, as shown at 51, a plurality of patients which visit, or about to visit, a certain clinical center for performing a medical imaging procedure is tagged. As used herein, a clinical center means one or more of the following centers: a hospital, an infirmary, a physician terminal, a medical imaging center, an online medical service, and the like.

Optionally, each one of the patients is tagged with a unique identification which may be stored and/or represented in medical imaging procedure tag such as a radio frequency identification (RFID) tag, a flash memory, a wireless flash memory, a removable smart card integrated circuit card (ICC), a code, a label and/or a bar code label. Optionally, the medical imaging procedure tag is integrated into a wearable article, such as a badge, a bracelet, a necklace, and/or a sticker which may be worn by the patient during his stay at the clinical center. Optionally, the medical imaging procedure tag is integrated into a document folder, a document bag, and/or a patient form which is given to the patient.

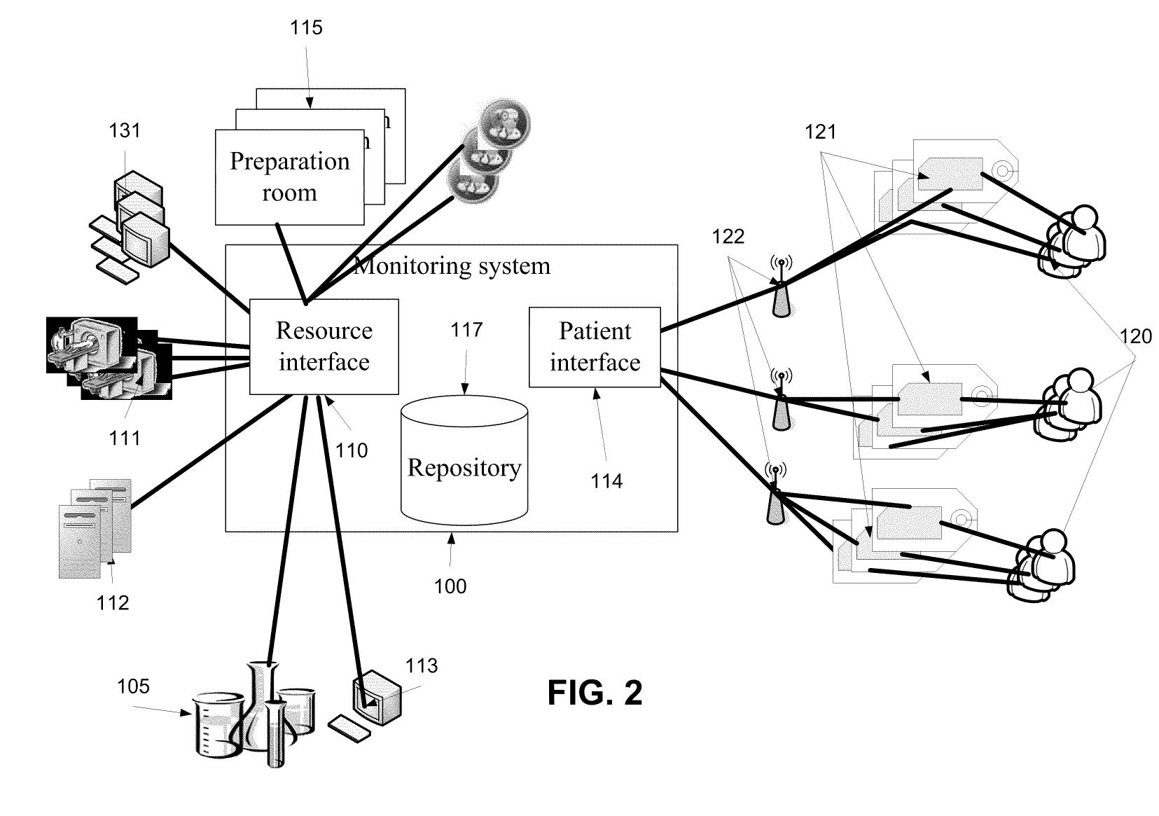

As shown at 52, the medical imaging procedure tags allow the monitoring system 100 to monitor a plurality of patients which are going through medical imagining procedures. As used herein, a medical imaging procedure means a procedure during which a patient is going through one or more of the following:
A reception process—a process during which the patient is registered and/or detected as a patient that initiates a medical imaging procedure at a clinical center. The reception process may include ordering one or more radiopharmaceutical preparations for the imaging acquisition process below, The reception process may be performed by the reception desk of the clinical center, a website that allows client to register by themselves, and/or by data received from a medical database, such as an ERP and/or PACS, for example as described below.
A medical imaging preparation process—a process during which the patient is prepared for a medical imaging acquisition. Optionally, the preparation includes a medical imaging waiting period.
An imaging acquisition process—a process during which one or more medical images of one or more organs of the patient are taken by one or more of the following scans: a positron emission tomography (PET) scan, a single photon emission computed tomography (SPECT) scan, ultrasound scan, magnetic resonance imager (MRI) scan, PET-computed tomography (CT) scan, an extracorporeal beta scan, an intracorporeal gamma scan, an intracorporeal beta scan, and/or a MAG3 scan. Optionally, the one or more medical images, which are optionally digital imaging and communications in medicine (DICOM) objects, are forwarded to a medical image database, such as the picture archiving and communication system (PACS). Optionally, the imaging acquisition process is a nuclear medical imaging procedure which is based on the output of a camera, such as disclosed in U.S. patent application Ser. No. 11/607,075, filed Dec. 1, 2006; U.S. patent application Ser. No. 11/034,007, filed Jan. 13, 2005; U.S. patent application Ser. No. 09/641,973, filed Aug. 21, 2000; PCT Patent Application No. PCT/IL2006/000562, filed May 11, 2006; PCT Patent Application No. PCT/IL2006/001291, filed on Nov. 9, 2006; PCT Patent Application No. PCT/IL2006/000840, filed Jul. 19, 2006; PCT Patent Application No. PCT/IL2006/000834, filed Jul. 19, 2006; PCT Patent Application No. PCT/IL2006/000059, filed Jan. 15, 2006; PCT Patent Application No. PCT/IL2005/001215, filed Nov. 16, 2005; PCT Patent Application No. PCT/IL2005/001173, filed Nov. 9, 2005; PCT Patent Application No. PCT/IL2005/000575, filed Jun. 1, 2005; PCT Patent Application No. PCT/IL2005/000572, filed Jun. 1, 2005; PCT Patent Application No. PCT/IL2005/000048, filed Jan. 13, 2005; and PCT Patent Application No. PCT/IL03/00917, filed Nov. 4, 2003; Israel Patent Application No. 172349, filed Nov. 27, 2005; and Israel Patent Application No. 171346, filed Oct. 10, 2005. The content of each one of the above documents is incorporated herein by reference as if fully set forth herein.
An imaging reacquisition process—a process during which one or more medical images of one or more organs of the patient are taken after previously taken medical images have been identified as unclear and/or inaccurate.
A diagnosis process—a process during which a diagnosis based on the one or more acquired medical images in provided. Optionally, the process includes a manual and/or an automatic analysis of the medical images. For example, the diagnosis may be provided by a physician, such as a radiologist that accesses the medical image via the PACS. In another example, the diagnosis may be provided by a computer aided diagnosis (CAD) system.
A reporting session—a process during which one or more the patient receive the outputs of the diagnosis process.
A revisit session—an event during which the patient returns to the clinical center for performing one of the aforementioned processes for second, third, fourth, and/or fifth time, for example as an outcome of a quality control (QC) check. Reference is also made to FIG. 2, which is a schematic illustration of a monitoring system 100 for monitoring image procedures held by a clinical center, optionally with the support of one or more radiopharmacy centers 105, according to some embodiments of the present invention. The monitoring system 100 interfaces with a plurality of medical imaging procedures resources 111-116 and a plurality of medical imaging procedure tags 121 of a plurality of monitored patients 120, for example as further described below.

The monitoring system 100 comprises and/or communicates with a repository 117 that stores a plurality of records; each documents a medical imaging procedure associated, for example by an identifier, with a patient 120 in the clinic center. The repository may be updated by a patient invitation system and/or any other medical database that includes medical information and medical imaging related information pertaining to patients, for example as described below.

The monitoring system 100 comprises a resource interface 110 for receiving, optionally in real time, status data from medical resources which participate in a medical imaging procedure, such as imagining modalities 111 and/or management systems thereof, radiopharmacy terminals 113 and/or management systems thereof, preparation rooms 115, caretakers 116 and/or from data management system that manage these resources and/or the work schedules practitioners involved in the imaging session, such as an enterprise resource planning (ERP) system 112 and an imaging scheduling management system. As used herein, a radiopharmacy terminal means a center for providing radiopharmaceutical preparations (RPs). As used herein, a RP means one or more radioactive isotopes that contain one or more byproduct materials combined with one or more chemical and/or biological materials and designed to accumulate temporarily in a part of the body of the patient for therapeutic purposes and/or for enabling the production of a useful image for use in a diagnosis of a medical condition.

Optionally, the resource interface 110 is configured to communicate with picture archiving and communication system (PACS). In such an embodiment, medical images, such as digital imaging and communications in medicine (DICOM) objects may be provided, as part of the medical imaging procedure, to a designated resource, such as a designated radiologist, a nurse, and/or an imaging system that uses the DICOM objects for analysis, diagnosis, and/or image capturing tuning. Optionally, data from the DICOM objects is used for updating the medical imaging procedure.

The monitoring system 100 comprises a patient interface 114 for interfacing with the medical imaging procedure tags 121 of the monitored patients 120. Optionally, the interfacing is performed by establishing a wireless communication link, optionally bidirectional, between the medical imaging procedure tags 121 and access points (APs) 122 such as wireless APs (WAPs), Bluetooth™ gateways, and Wi-Fi™ routers which are positioned in the clinical center. Optionally, the APs 122 are positioned in a proximity to certain medical imaging procedures resources 111-116 in a manner that allows the detection of patients which are located in proximity thereto. Such proximity may indicate that certain patients are in certain stage of the medical imaging procedure. For example, an AP 122 may be positioned in a medical imaging modality room, detecting patients which are at the aforementioned imaging acquisition and/or reacquisition processes. An AP 122 may be positioned in a physician room, detecting patients which currently going through the reporting processes.

Optionally, the monitoring system 100 comprises one or more clinical center terminals or modules 131, which are connected to and/or installed on the medical imaging management and/or order systems of the clinical centers in which medical imaging procedures are being monitored. Such clinical center terminals 131 may be used for uploading, either manually or automatically, data related to the aforementioned medical imaging procedures, data related to the RPs of the aforementioned medical imaging procedures and/or medical information that are related to respective patients. As used herein, medical information means, inter alia, information that is related to the patient, such as laboratory results, body mass index (BMI), therapeutic procedure records, clinical evaluations, age, gender, medical condition, ID, genetic information, patient medical record, data indicating of metabolism, blood pressure, patient history, sensitivities, allergies, different population records, arrhythmias, treatment methods and the outcome thereof, epidemiologic classification, and patient history, such as treatment history.

The medical imaging related information may include, for example, one or more of the following:

the type of the requested medical imaging;

the one or more organs which are about to be imaged;

the protocol of the requested medical imaging, for example a fast acquisition protocol, scottsdale medical imaging (SMI) protocol, and a dynamic protocol;

one or more clinical questions or evaluations to which the medical imaging procedure is designed to provide answers, for example questions which are related to blood flow, perfusion defect, apoptosis, dynamic quantitative assessments, kinetics quantitative assessments, tumor Activity, therapeutic drug prediction, drug monitoring, DNA synthesis/proliferation, and/or the metabolic retention;

the radiopharmaceutical preparation that is needed for the requested medical imaging, pricing information about the radiopharmaceutical preparation; and

any information that is needed for preparing the radiopharmaceutical preparation. In some cases, a range or a plurality of allowed possibilities are provided.

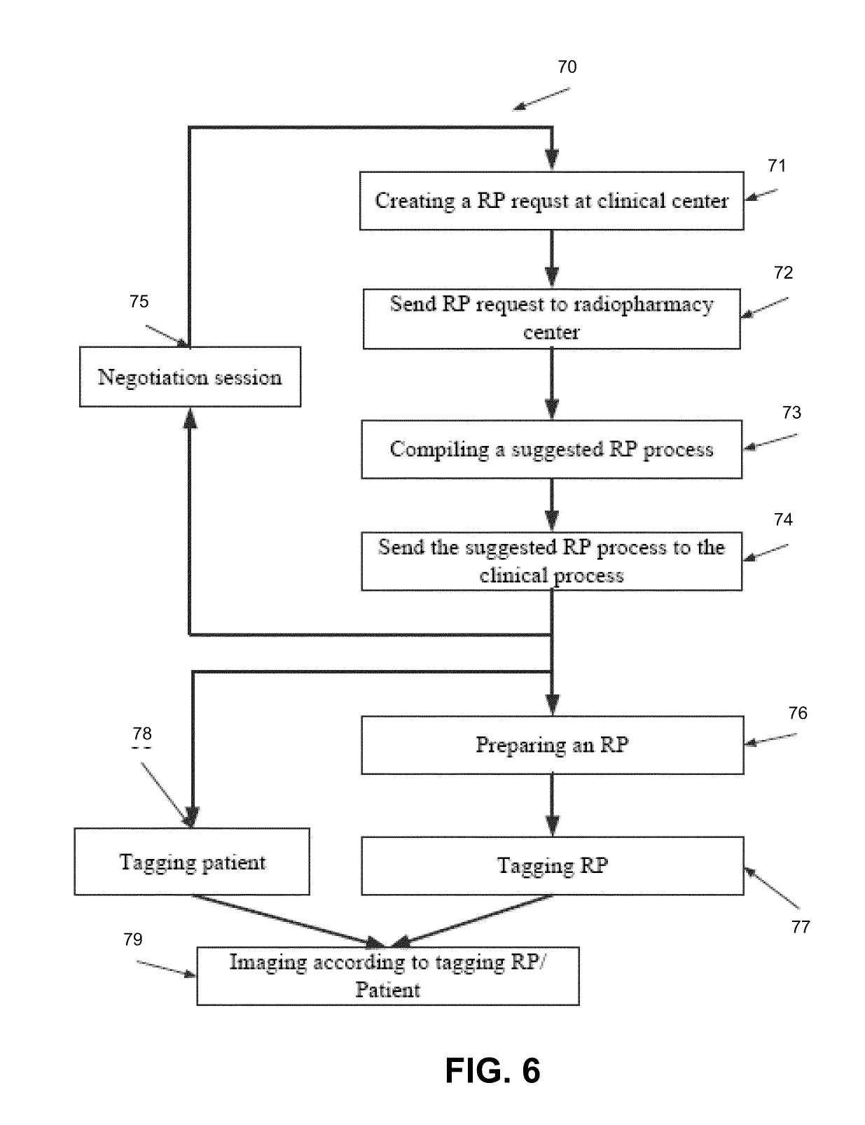

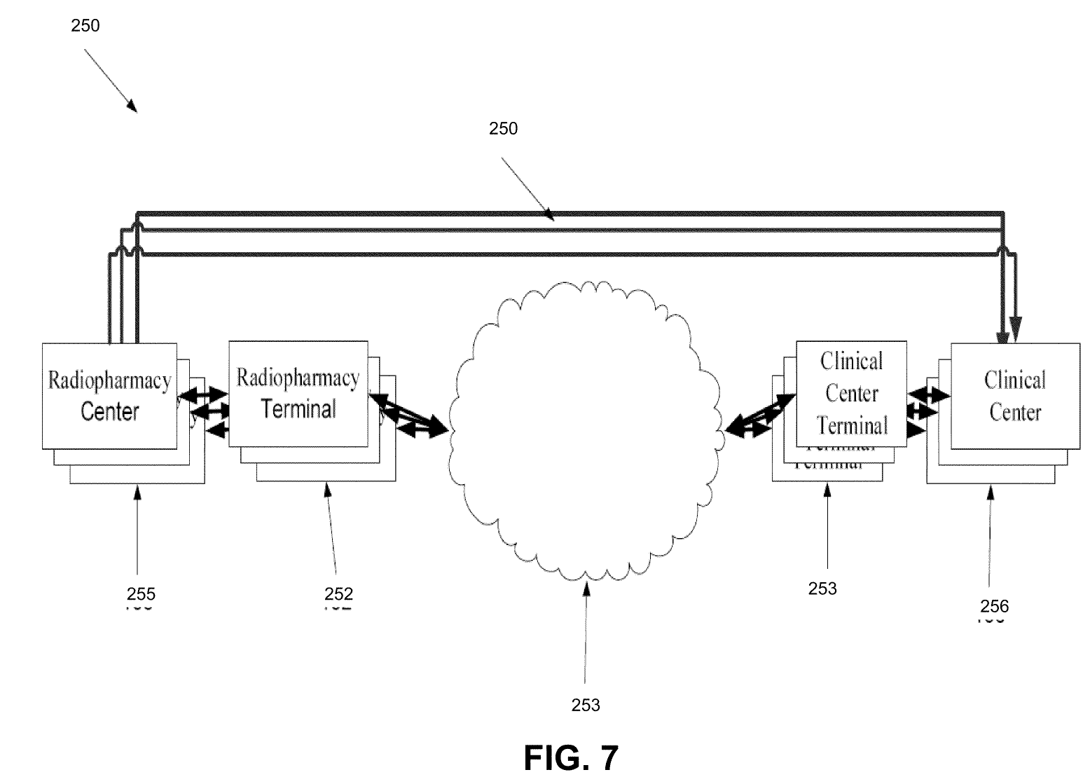

As described above, the monitoring system 100 comprises one or more radiopharmacy terminals or modules 113 which are connected to and/or installed in a data management system of the radiopharmacy centers 105. The radiopharmacy centers 105 may includes remote laboratories, local laboratories, and/or mobile laboratories, referred to herein as hot labs. Optionally, if the medical imaging procedure is a radio medical imaging procedure, an RP request is generated during the reception process according to information that is received manually by a medical caretaker, such as a physician or a nurse, and/or automatically, via the procedure scheduling management system. The RP request includes clinical information and an imaging schedule, such as the exact or approximate time during which the requested imaging is about to performed. The clinical information includes medical information and/or medical imaging related information. Optionally, the RP request includes a patient identifier (ID), such as an ID number, a name, and/or a patient number and medical information that is related to the patient. The management of the RP request and the generation thereof are further described below with regard to FIGS. 6 and 7.

As described above in relation to numeral 52, the monitoring system 100 allows monitoring a plurality of patients during the medical imaging procedure. Optionally, each one of the patient 120 receives, when she begins a medical imaging procedure, a medical imaging procedure tag 122 that is uploaded and/or tagged with identification information and optionally with medical imaging related information, medical information and/or reference thereto.

In some embodiments of the present invention, the monitoring system 100 monitors the progress of each one of the patients in a medical imaging procedure which is designated thereto. The medical imaging procedure tags 122 allows the monitoring system 100 to receive information about the current location of the patient 120 in the clinical center and to deduce the current medical imaging procedure stage in the medical imaging procedure she is going through.

The monitoring system 100 may be used for monitoring the correspondence of between the patient's current medical imaging procedure stage and a requested medical imaging procedure timeline.

Optionally, the monitoring system 100 may be used for reordering the queues for the aforementioned resources according to emergencies and/or medical imaging procedures which have been designated as urgent. Optionally, the system operator can change the order of importance of the monitored medical imaging procedures. Optionally, the monitored medical imaging procedures are ranked according to their urgency, for example according to the related medical information.

As outlined above and further described below, the medical imaging procedure may be a nuclear medical imaging procedure. Such procedures are performed with one or more different tracers or a cocktail of tracers, such as Tl, Tc, I123, and In. Optionally, the procedure includes the injection of a mixture of isotopic tracers to the patient. As used herein a tracer means an isotropic tracer, an antibody and/or a radiopharmaceutical that modulates one or more target tissue properties.

Usually, as further explained below, such a nuclear medical imaging procedure involves ordering one or more radiopharmaceutical preparation (RP) that is injected to the patient during the preparation process. As used herein, a radiopharmaceutical preparation (RP) means one or more doses of one or more radioactive isotopes that contain one or more byproduct materials combined with one or more chemical and/or biological materials and designed to accumulate temporarily in a part of the body of the patient for therapeutic purposes and/or for enabling the production of a useful image for use in a diagnosis of a medical condition. Such an RP request is sent to one or more radiopharmacy terminals 105, optionally via a communication network, such as the internet and a telecommunication network, optionally as part of the reception process. Optionally, the RP request includes the medical information and the medical imaging related information pertaining to the respective patient and medical imaging procedure. Optionally, the RP request includes an order of materials which are required in the related imaging medical procedure, for example contrast agents and/or stress agents, for example contrast and/or stress agents of a CT procedure.

The RP request allows a related radiopharmacy center 105 to prepare the radiopharmaceutical preparation according to the clinical information and/or the imaging schedule which are defined in the RP request, for example as described below with regard to FIGS. 6 and 7.

As commonly known, different RPs having different decay profiles in different patients. As described above each medical imaging procedure that is document in the monitoring system may be associated with one or more RPs which is designated to be used in during the imaging acquisition process. For example, when the designated RP arrived at the clinical center, the medical imaging procedure begins.

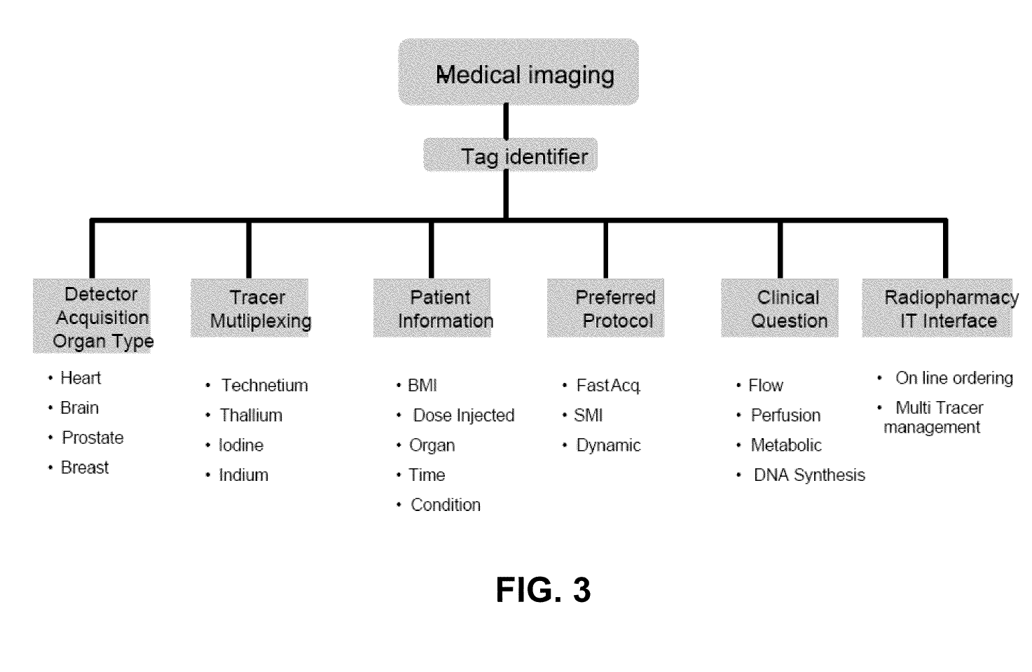

In use, the monitoring system 100 calculates the decay profile of the RP, optionally while taking into account the efficacy thereof during different periods along the decay profile. The decay profile is calculated according to characteristics of the RP and/or the patient that is going to be injected therewith. Examples for different types of data which are related to a radiopharmaceutical preparation and/or the patient and may be taken into account during such a calculation are depicted in FIG. 3. Then, the monitoring system generates a timeline that indicates a period during which the patient should go through the imaging acquisition process and/or preparation process. This timeline, together with a plurality of timelines of a plurality of medical imaging procedures are monitored to assure that the imagining modalities 111 and/or preparation rooms 115 are utilized efficiently. For example, the order of queues for using each one of these resources and/or any other resources may be dynamically changed to improve the efficacy of the RPs during the imaging acquisition processes and/or improving the utility of these resources. Optionally, the system 100 is connected to displays and/or computing units that allow presenting dynamic queues to the patients and/or the caretakers of the clinical center.

Additionally or alternatively, the monitoring system 100 may adjust monitored medical imaging procedures according to dose changes in the RP. For example, when the decay profile of a certain RP is too short and the dose thereof is changed for extending the decay profile thereof, the monitored medical imaging procedure is updated. Clearly, such a change may affect the ranking of the monitored medical imaging procedure.

Additionally or alternatively, each monitored medical imaging procedure may be used for adjusting the medical imaging scan that is performed during the medical imaging acquisition stage. In such an embodiment, the monitoring system 100 may send imaging instructions to respective modalities and/or to respective modality operators.

Additionally or alternatively, each monitored medical imaging procedure may include a number of medical imaging acquisition sessions, a number of dose administering sessions and/or medical imaging preparation processes. For example, the monitored medical imaging procedure may require the administrations of a plurality of doses of an RP that includes a plurality of tracers, each having a different decay profile and/or a different kinetic pattern. In such an embodiment, the order and/or the timeline of the medical imaging acquisition processes, the dose administering sessions and/or medical imaging preparation processes is determined according to a waiting period that is needed between the imaging acquisition processes. Optionally, the waiting period is determined according to the type of the RP and/or the medical information of the patient. Optionally, the waiting period is determined according to activity performed by the patient after the injection of the RP. The waiting period may be few minutes, hours, and days. It should be noted that the waiting period may be limited to ensure a high efficacy of the injected RP. As commonly known, the effect of the isotope injection may be traced by the imaging cameras for hours or days after the injection has been given to the patient. In such an embodiment, the monitoring system 100 may adjust the timelines of the respective medical imaging procedures according to the duration of the effect of the RP and/or an estimated absorption thereof in a target tissue or cells and/or in a background tissue. For example, if the effect of isotope A usually lasts approximately 5 days, the suggested RP process defines a gap of at least 6 days between the injection of the isotope A and the next medical imaging session. Optionally, the monitored medical imaging procedure is similar to the medical imaging procedures which are described in U.S. Patent Application Pub. Number 2008/0230705, published on Sep. 25, 2008 and in U.S. patent application Ser. No. 11/989,223, filed on Jul. 19, 2006, which are incorporated herein by reference.

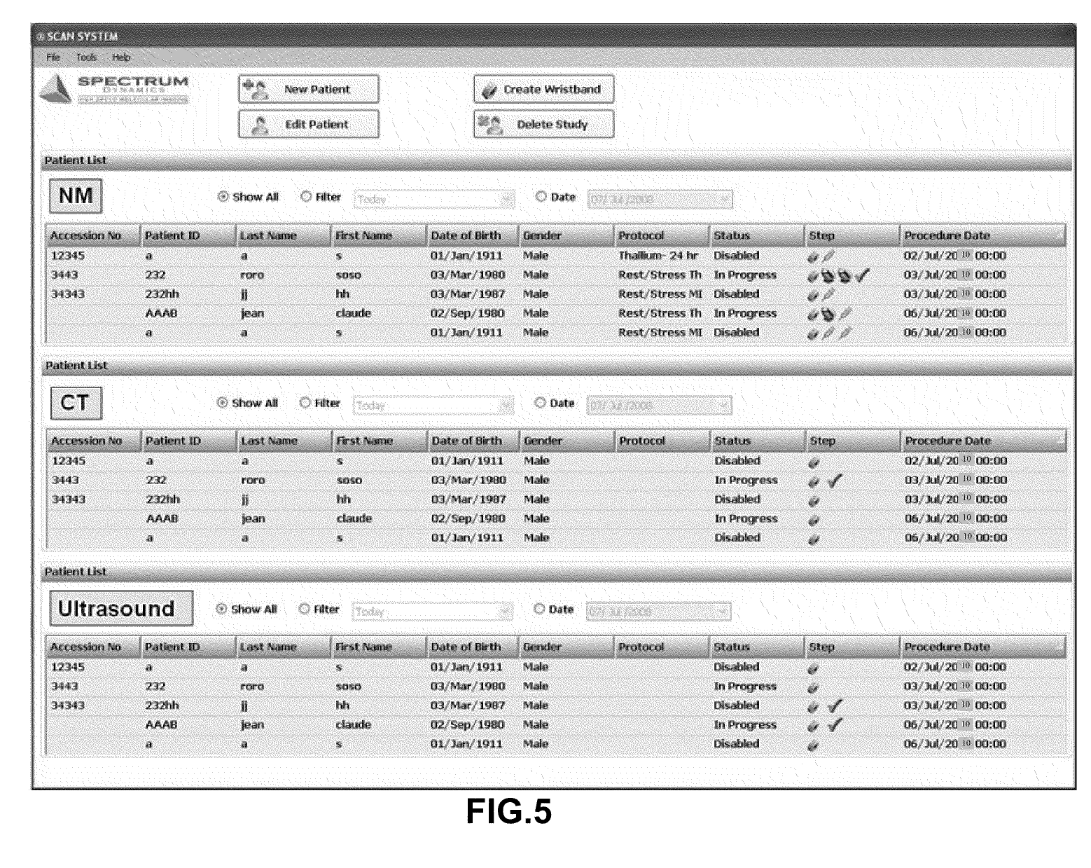

As shown at 53, the monitoring system can now generate a report that is based on the monitored medical imaging procedures. Optionally, the report may indicate where some or all the patients are physically located, for example according to the communications of the tags 121 with APs which their location is mapped by the monitoring system 100. Optionally, the report may indicate or alert the system operator about current and/or potential resource inefficiency, such as overload bottlenecks. Optionally, the monitoring system 100 is configured for alerting the system operator and/or caretakers about potential resource inefficiency and/or medical imaging procedures exceptions. Optionally, the monitoring system 100 is configured for sending an SMS and/or an email to designated numbers and/or addresses and/or to present the alerts on a client terminal connected to the monitored system 10, such as 131. For example, FIG. 5 is an exemplary screenshot of a report that may be displayed on one of the client terminals 131 and/or on a screen that is connected to the monitoring system 100. The report, which is optionally dynamic report that describes the current stage of a plurality of medical imaging procedures, shows the stage/step of medical imaging procedures, the protocol used during the imaging acquisition process, and data related to the respective patients.

Optionally, the monitoring system 100 may be configured to respond to an indicia about one or more specific patient, for example their location, the stage of the medical imaging procedure there are going through, errors and/or exceptions between their location and the planned medical imaging procedure, exceptions in the planned timeline and the like. Optionally, the monitoring system 100 is configured for alerting the system operator and/or caretakers about medical imaging procedures exceptions. Optionally, the monitoring system 100 is configured for alerting patient 120 about medical imaging procedures exceptions, for example by sending a notification to their medical imaging procedure tags 121 and/or to their communication devices, for example as an SMS or an email. In such an embodiment, the address of the communication devices may be extracted from information provided during the reception process, the medical information and/or data management systems 112.

Additionally or alternatively, the system may be used for monitoring the injection of the RP to patients. In such embodiment, the RP is provided in a radiopharmaceutical container, such as a syringe and/or a radiopharmaceutical pig device, which is tagged with a container identification tag. The container identification tag may be stored and/or represented in a radio frequency identification (RFID) tag, a flash memory, a wireless flash memory, a removable smart card integrated circuit card (ICC), a code, a label and/or a bar code label that is attached to the RP. The container identification tag indicates, tags and/or links to data that define the RP stored in the container, patient identification information and some or all of the clinical information which have been received in the RP request. In such an embodiment, the monitoring system 100 may manage a list of the RP containers and optionally, their location. The monitoring system 100 optionally manages the preparation of the RP and/or the status thereof, for example the lifescan thereof. In such an embodiment, the monitoring system 100 may be used for managing the conveying of the RPs from an RP repository to the preparation room which is designed to the respective patient and/or the preparation process, for example the time during which a certain RP is combined with another before an estimated injection thereof to the patient.

Optionally, the monitoring system 100 provides a real-time control over the management of the medical imaging procedures. In such an embodiment, changes that occur in the medical caretaker staff schedule, and/or resource status can be take into account. For example, the monitoring system 100 may generate alerts, queues order instructions and/or reports, for instance as described above, and/or and other outputs that adjust the monitored medical imaging procedures. Such an adjustment may allow avoiding a reduction to the efficacy of the clinical center, an increment to the maintenance costs thereof, and/or an increment the waiting time of one or more patients.

Optionally, the changes which may be detected by the inputs received via the resource and/or patient interfaces 110, 114 includes changes to patient information, RP orders, RP supply, scheduling and/or pharmaceutical preparation, availability of modalities 111, availability of radio-pharmacy centers 105, and the presence of patients 120 in the clinical center. For example, management of the medical imaging procedures may be managed according to the actual arrival time of the patients. In such a manner, coming late patients do not create an unexpected overload one or more of the aforementioned resources.

Optionally, a real-time display of status of the medical imaging procedure is available to some or all the network client terminal 131. As used herein a client terminal means a personal computer, a laptop, a personal digital assistant (PDA), and a Smartphone.

Optionally, the monitoring system 100 provides a real-time report and/or instructions to radiopharmacy centers 105 about the RPs they should prepare and the requested delivery time. In such a manner, the preparation of the RPs and/or their delivery is coordinated with the medical imaging procedures.

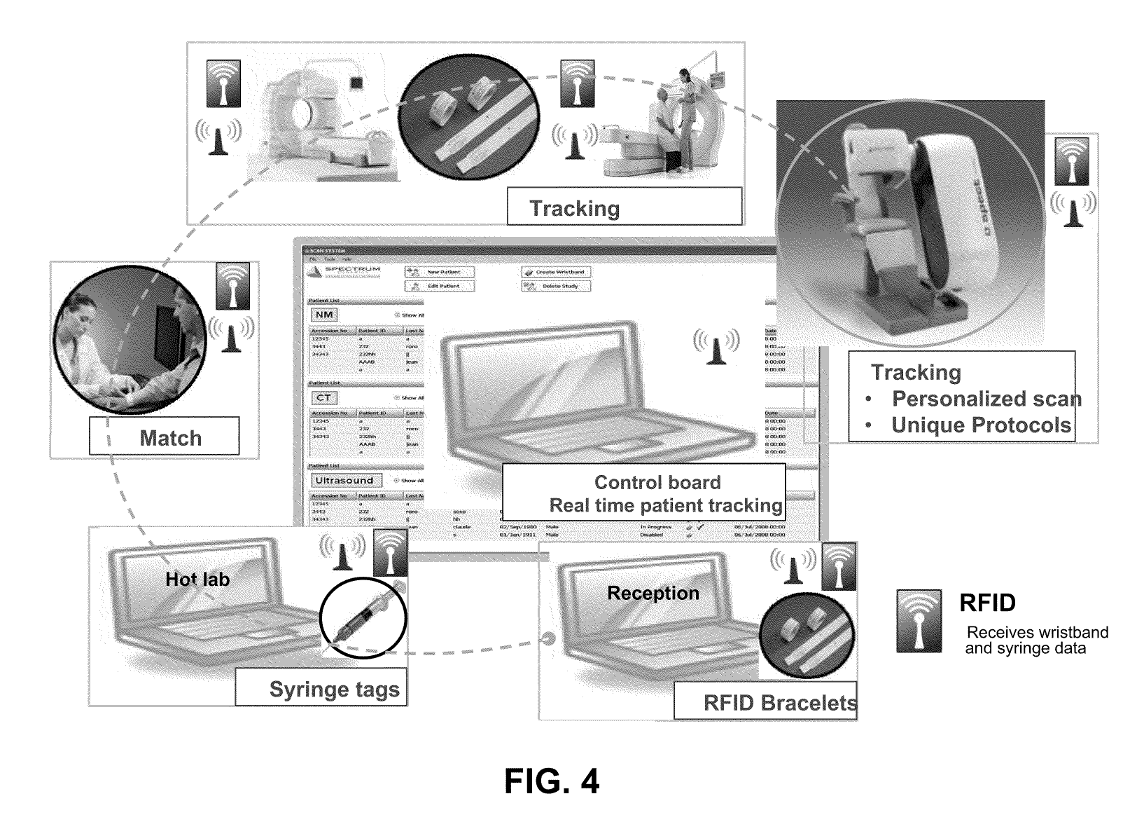

A schematic illustration of an exemplary nuclear medical imaging procedure performed according to the method that is depicted in FIG. 1 and/or the system depicted in FIG. 2 is provided in FIG. 4.

Reference is now made to FIG. 6, which is a flowchart 70 of a method for preparing one or more patient dependent radiopharmaceutical preparations, according to some embodiments of the present invention. Reference is also made to FIG. 7, which is a schematic illustration of a system 250 for synchronizing between one or more clinical centers 256 and one or more radiopharmacy centers 255, according to some embodiments of the present invention.

The system 250, similarly to the system that is depicted in FIG. 2, comprises one or more clinical center terminals or modules 251, which are connected to and/or installed on the medical imaging management and/or order systems of the clinical centers 256. The system 250 further comprises one or more radiopharmacy terminals or modules 252 which are connected to and/or installed on a data management system of the radiopharmacy centers 255. For example, each clinical center terminal 251 may be connected to the medical imaging scheduling management system of the clinical center 256, for example, to the enterprise resource planning (ERP) system thereof. Each radiopharmacy terminal 252 may be connected to the radiopharmaceutical preparation management system of the respective radiopharmacy center 255, for example, to the enterprise resource planning (ERP) system thereof. For brevity, the aforementioned modules may be referred to herein as terminals.

First, as shown at 71, the clinical center terminal 251 generates an RP request according to information that is received manually by a medical caretaker, such as a physician, and/or automatically, via the procedure scheduling management system. The medical information may be generated and/or processed by a central processing system in a medical imaging facility, such as an R-SCAN facility. The information is written, programmed, and/or stored in a machine readable media, such as a barcode, a 2D code, an electronic tag, an RFID tag, and the like. Optionally, the machine readable media is associated with the patient, for example located on a wrist band, and/or with one or more of the pharmaceuticals to be administered. The machine readable media is read by an imaging system for configuring is activity. The RP request includes clinical information and an imaging schedule, such as the exact or approximate time during which the requested imaging is about to performed. The clinical information includes medical information and/or medical imaging related information. Optionally, the RP request includes a patient identifier (ID), such as an ID number, a name, and/or a patient number and medical information that is related to the patient.

The medical imaging related information may define a procedure that sets up the link between a patient with a certain diagnosis and the medical imaging process with a certain RP. The protocol may be for diagnostics and/or therapeutic purposes.

Optionally, the RP request may define a request for a number of nuclear medicine imaging procedures, each with one or more different tracers or a cocktail of tracers, such as Tl, Tc, I123, and In.

Optionally, the RP request may define a request for an RP process that includes the administering of a mixture of isotopic tracers to the patient.

In use, the medical caretaker may place an order for an imaging procedure, such as PET and SPECT, and PET-CT in a prospective time and the clinical center terminal 251 generates the RP request accordingly. Optionally, the desired procedure and/or radio-pharmaceutical are automatically selected, for example, using a table, an expert system, a neural network and/or a learning system. Optionally, optimization methods as known in the art are used.

Then, as shown at 72, the RP request is sent to one or more radiopharmacy terminals 252, optionally via a communication network 253, such as the internet and a telecommunication network.

Each radiopharmacy terminal 252 receives the RP request and allows a related radiopharmacy center 255 to prepare the radiopharmaceutical preparation according to the clinical information and/or the imaging schedule which are defined in the RP request.

Optionally, as shown at 73 and further described below, the radiopharmacy terminal 252 generates a suggested RP process according to the clinical information and/or the imaging schedule which are defined in the RP request. The suggested RP process includes data, such as radiopharmaceuticals concentration, radiopharmaceutical doses, radiopharmaceutical concentration, and doses ratios and/or any other data element that in the provided in the RP request. Optionally, the suggested RP process includes data about the radiopharmaceutical preparation generation process, such as time and/or method of manufacturing. As shown at 74, the suggested RP process is sent, optionally using the radiopharmacy terminal, via the communication network 253, to the requesting clinical center.

In some embodiments of the present invention, the radiopharmacy center 255 adjusts and/or determines the radioactivity of the suggested RP process according to the imaging schedule and/or the clinical information. Optionally, the radioactivity is tuned by selecting different radiopharmaceuticals. Optionally, the radioactivity is tuned by adjusting the radiopharmaceuticals concentration, radiopharmaceutical doses, radiopharmaceutical, concentration and doses ratios. Optionally, the radioactivity is tuned by adjusting the preparation period of the radiopharmaceutical preparation. As commonly known radioactivity of radiopharmaceutical preparations decreases over time and therefore the preparation time has an effect in their radioactivity.

Optionally, the radiopharmacy center 255 selects different radiopharmaceuticals or the doses thereof according to the pace of the heart of the patient. When the patient has arrhythmias the electrical activity of the heart is irregular or is faster or slower than normal. Such changes may affect the imaging process and the selections and/or adjusting of the radiopharmaceutical preparation may improve the outcomes thereof.

Optionally, the clinical information is used for adjusting the suggested RP process. As described above, the clinical information may include pricing information about the radiopharmaceutical preparation. Such pricing information may define the price the clinical center 256 is ready to pay for the requested radiopharmaceutical preparation. In such an embodiment, the radiopharmaceutical preparation comprises a composition that is defined according to the pricing information. For example, is a first component or composition of components costs 25$ and a second component or a composition of components costs 12$ and the pricing information define 11$, the radiopharmacy selects the first component or composition of components. Optionally, cost and/or other considerations affect the decision which radio-pharmacy to use.

As described above, the RP request may define a request for an RP process that includes the administering of a mixture of tracers, such as isotopic tracers to the patient, for example a mixture of technetium and thallium agents. The imaging schedule and/or the clinical information may have an effect on the optimal ratio of the agents. In such an embodiment, the imaging schedule and/or the clinical information may be used for adjusting the agent ratio. For instance, while the optimal mixture for a patient with a first BMI or a first weight is a first mixture, the optimal mixture for another patient with a second BMI or a second weight may differ. Optionally, the mixture may be adjusted according to any other medical information. Annex A, which is attached to this description and incorporated herein by reference provides an example for a process for combining tracers that may be adjusted in the process that is depicted in FIG. 6 and/or described herein.

As described above, the RP request may define a request for an RP process that comprises a number of medical imaging sessions with different isotopes and/or isotope concentrations. The radiopharmacy terminal 252 may generate the suggested RP process according to the duration of the effect of the isotopes and/or isotope concentrations.

In some embodiments of the present invention, the radiopharmacy terminal 252 and the clinical center terminal 251 are designed to establish a negotiation session between them, for example as shown at 75. As described above, the clinical center terminal 251 sends a RP request to the radiopharmacy center 255 via the radiopharmacy terminal 252. The radiopharmacy center 255 may now prepare the radiopharmaceutical preparation according to the clinical information and/or the imaging schedule which are defined in the RP request, as shown 73. Optionally, before the radiopharmaceutical preparation is made, the radiopharmacy center 255 sends a message that includes suggested RP process to the clinical center 256, optionally using the radiopharmacy terminal 252, via the communication network 253. The message may be referred to herein as a suggestion message. The suggested RP process may include the radiopharmaceuticals, radiopharmaceutical doses, radiopharmaceutical concentration, concentration and doses ratios, and/or any other information, tag, and/or links that indicates which radiopharmaceutical preparation the respective radiopharmacy center 255 designs to prepare and sent according to the request. Optionally, the radiopharmacy terminal 252 may send a suggestion message that indicates it cannot comply with the RP request, for example due to a low pricing. Such a suggestion message allows the clinical center 256 to accept the suggested RP process, to decline the suggested RP process, and/or to send a new RP request, for example with a new pricing. In should be noted that the negotiation sessions 75 may be performed in any number of iterations, as shown in FIG. 6.

As described above, the RP request may be sent to a plurality of radiopharmacy terminals 252. In such an embodiment, the clinical center 256 may select the message with the suggested RP process that is most similar to the requested radiopharmaceutical preparation, use the clinical center terminal 251 to send an accept message to the respective radiopharmacy terminal 252 and decline messages to all the other radiopharmacy terminals 252.

Optionally, the RP request comprises a quantity field for allowing defining the number of portions of the radiopharmaceutical preparation. In such an embodiment, the clinical center 256 may accept a number of suggested RP processes to fill up the number of portions.

Now, as shown at 76, the radiopharmacy terminals 252 prepare the radiopharmaceutical preparation, optionally according a suggested RP process which has been accepted by the clinical center 256. Similarly to the described above, the radiopharmaceutical preparation is inserted into a radiopharmaceutical container, such as a syringe and/or a radiopharmaceutical pig device. As shown at 77, each radiopharmaceutical container is tagged with a container identification tag, for example the aforementioned container identification tag.

As shown at 78, the tagged radiopharmaceutical containers are sent to the requesting clinical center 256 and/or to any other clinical centers 256 which may be defined in the RP request. Optionally, a machine readable media including medical information pertaining to the patient is attached to the tagged radiopharmaceutical containers so as to allow a match to the patient before the administering of the RP.

In an exemplary embodiment of the invention, real-time control over the process is provided. For example, as changes occur, such as in patient information, scheduling and/or pharmaceutical preparation, the various actors (e.g., radio-pharmacy, patient, imaging clinic) are updated in real-time and change their clinical plan and/or schedule accordingly. Optionally, a real-time display of status is available to some or all participants in the network.

As shown at 78, the clinical center 256 may generate a patient identification tag that indicates and/or tags and/or linked to data that define the radiopharmaceutical preparation which have been requested and/or accepted by the clinical center 256. The patient identification tag is optionally stored and/or represented as described above in relation to the container identification tag. Optionally, the patient identification tag and/or the device that stores it, as described above, are attached and/or integrated into a wristband, a band, a sticker, and/or any other tag carrier that may be attached to the patient's body. The respective patient is optionally attached with the patient identification tag. Optionally, the patient identification tag is provided to the patient either in the clinical center 256 and/or sent thereto, for example with a reminder and/or a medical imaging invitation.

Now, as shown at 79, a nuclear medicine imaging process, such as an imaging process that is based on an extracorporeal beta scan, an intracorporeal gamma scan, an intracorporeal beta scan, a MAG3 scan, a PET scan, a PET-CT scan, and/or a SPECT scan is now performed according to the patient and/or container identification tags. The nuclear medicine imaging process may be based on the output of a camera, as defined in the aforementioned patents.

As described above, the patient and/or container identification tags include data on the radiopharmaceutical preparation that is used in the respective imaging and clinical information that is related to the imaged patient. By adjusting the nuclear medicine imaging process to the radiopharmaceutical preparation and/or to the clinical information, the amount of radiation to which a patient is exposed is reduced, optionally by using a radiopharmaceutical preparation that is adjusted to his body and/or pathological characteristics.

An example for different types of data which are related to a radiopharmaceutical preparation and/or the patient and may be taken into account during the nuclear medicine imaging process that is depicted in FIG. 3.

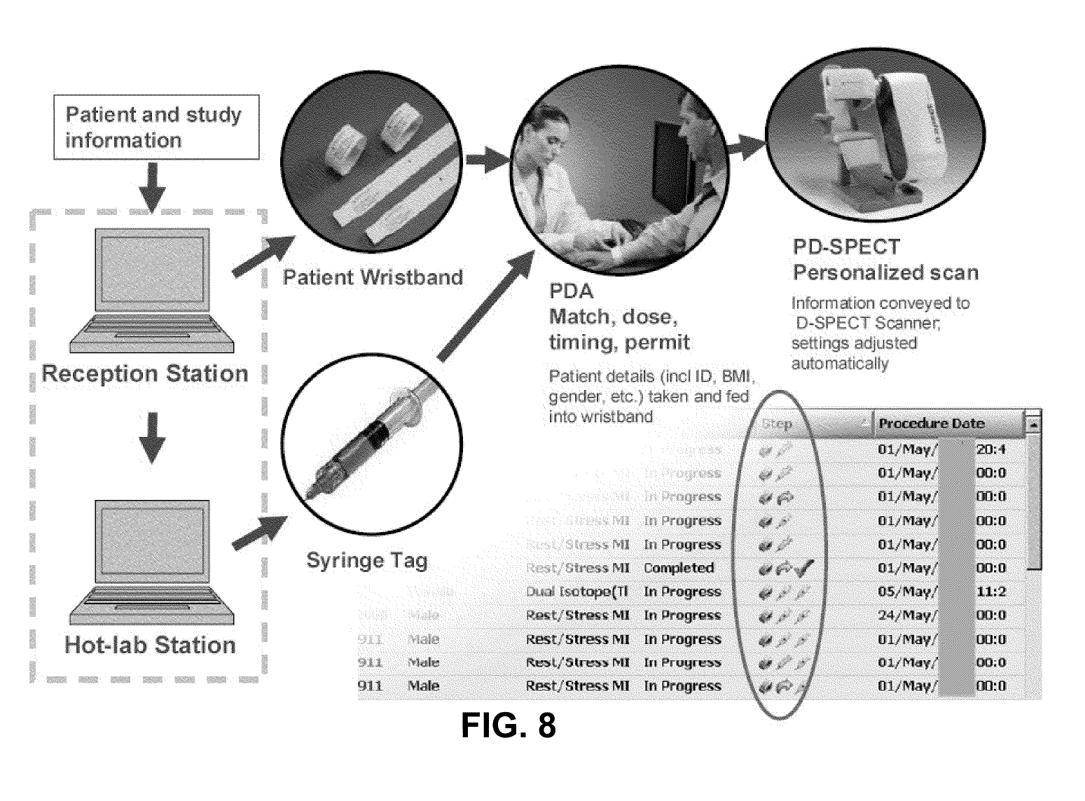

A schematic illustration of an exemplary nuclear medicine imaging process of using a SPECT camera that is performed according to the method depicted in FIG. 6 is provided in FIG. 8.

As described above, the clinical center 256 may accept or decline suggested RP process. Optionally, the accept message that is sent in response to an accepted suggested RP process comprises an acceptance identifier, such as a unique number. Optionally, receiving the radiopharmacy terminal 252 attaches the acceptance identifier to the container identification tag and the clinical center terminal 251 attaches the acceptance identifier to the patient identification tag. In such an embodiment, a match between the acceptance identifier of the patient identification tag and the acceptance identifier of the container tag may be performed in order to assure that the patient receives the right radiopharmaceutical preparation.

As described above, the systems depicted in FIGS. 2 and 7 allows monitoring nuclear imaging procedures and the preparation of RPs which are used in the nuclear imaging procedures. In such a manner, RPs may be injected according to their concentration-time profiles to achieve the best results. Furthermore, as the decay profile of the RP may be monitored, the number of RPs which are expired without use may be avoided and/or reduced. In such a manner, costs may be reduced and ineffective and/or redundant nuclear imaging procedures may be avoided. The importance of such monitoring may be even greater when the RPs comprises a mixture of tracers, such as isotopic tracers. Such RPs usually require greater care and monitoring. For example, the presence of one tracer may affect the decay profile of another tracer in the RP and therefore a cumulative concentration-time profile has to be calculated. Another example is that different organs have different absorption rates to tracers. Therefore, different ratios between the tracers are defined for imaging different organs. Such versatility require careful monitoring on the preparation and usage process.

Using a number of tracers simultaneously allows multiplexed imaging of the one or more imaged organs, for example using single photon emission computed tomography (SPECT) imaging.

The multiplexed imaging allows a differential diagnosis and/or staging that allows reducing costs and/or time of the nuclear imaging and diagnosis procedures and an improvised diagnostic flow. The multiplexed imaging further allows analyzing drug kinetics in various tissue pathologies and visualizing a number of organs and/or tissues simultaneously.

Some mixtures create a highly specific RP. The absorbance of a number of tracers, such as isotopic tracers, in a single tissue may be indicative of combination of probed symptoms and/or signs.

It should be noted that using multiple isotropic tracers allow selecting chemicals, peptides and/or antibodies which are suitable for selected target pathologies and imaging several different aspects of one or more probed organs simultaneously. Furthermore, such mixtures allow imaging specific activity for improved emission rate and may have long decay profile that allows easy and relatively low handling cost.

Reference is now made to RPs that includes a plurality of tracers, which are designed for multiplexed imaging for diagnosing various kinds of cancerous tissues. It should be noted that the isotropic tracers may be injected simultaneously, for example as a mixture or consecutively, for example according to the intake and/or concentration pattern of the isotropic tracers in a target tissue or cells and/or the intake of the isotropic tracers in a background tissue or cells. For instance, an RP may include an antibody, such as Thymidine and/or Arcitumomab carcinoembryonic antigen (CEA), that is injected to a patient more than 24 hours before an imaging procedure, such as a SPECT imaging procedure, enabling its detection and localization by scintigraphy and a radiopharmaceutical, such as Sestamibi Tc^{99m} that is injected few hours before the SPECT imaging procedure, enabling the marking of tumor activity. By scheduling the injection of the tracers according to their intake and/or concentration patterns, a simultaneous imaging of a number of targeted pathologies is facilitated without reducing their intake and/or concentration rates during the imaging session.

A first RP is designated for lung cancer diagnosis. Imaging using this RP may allow avoiding the considerable risks which are involved in lung biopsy when a surgery diagnosis is considered. The first RP includes at least two of the following tracers:

Sestamibi Tc^{99m} for marking tumor activity/metabolism;

Tl201 for marking blood flow;

Teboroxime Tc^{99m} for marking blood flow;

Thymidine I¹²³ for marking proliferation/DNA synthesis; and

PK-11195+I¹²³/In¹¹¹ for marking macrophages.

A second RP is designated for colorectal cancer diagnosis. Imaging using this RP may allow using nuclear imaging procedures instead of Colonoscopy which is invasive and uncomfortable for patient and/or virtual colonoscopy that unable to detect polyps which are smaller than 10 mm in diameter. The second RP includes at least two of the following tracers:

Sestamibi+Tc^{99m} for marking tumor activity;

Arcitumomab carcinoembryonic antigen (CEA) Scan Tc^{99m} for marking antibody to carcinoembryonic antigen;

Tl201 for marking blood flow;

Teboroxime+Tc99m for marking blood flow;

Avastin+In¹¹¹ for marking tumor specific antibody;

Thymidine+I¹²³ for marking proliferation/DNA synthesis; and

PK-11195+I¹²³/In¹¹¹ for marking macrophages.

A third RP is designated for breast cancer diagnosis. Imaging using this RP may allow using nuclear imaging procedures instead of mammography, which have 15%-30% false negatives and 20%-35% false positives, Ultrasonography that has low specificity and is strictly operator dependent with various results, MRI which is expensive and has less than 70% specificity at a sensitivity of 95% and/or 18F-Fluorodeoxyglucose(FDG) imaging that is expensive and have limited clinical experience and availability of PET, and Scintimammography which is not reliable for tumors which are less than 1 cm in diameter. The third RP includes at least two of the following tracers:

Sestamibi+Tc99m for marking tumor activity;

Tl201 for marking blood flow;

Teboroxime+Tc^{99m} for marking blood flow; Herceptin+I¹²³ for marking Her2 specific antibody; and

PK-11195+I¹²³/In¹¹¹ for marking macrophages.

A fourth RP is designated for prostatic adenocarcinoma diagnosis. Imaging using this RP may allow using nuclear imaging procedures instead of biopsies. The fourth RP includes at least two of the following tracers:

Sestamibi+Tc^{99m} for marking tumor activity; and

J-591 labeled with In¹¹¹ for marking prostate-specific membrane antigen (PSMA) specific antibody.

The fifth RP is designated for Lymphoma diagnosis. The fifth RP includes at least two of the following tracers:

Rituxan+In¹¹¹ for imaging of Rituxan function and dosimetry;

Thymidine+I123 for DNA synthesis;

Ga⁶⁷ for marking glucose metabolism;

Sestamibi+Tc99m for marking tumor activity; and

Teboroxime+Tc99m for marking blood flow.

A sixth RP is designated for heart functioning diagnosis. This RP may include Thallium 201 and Sestamibi Tc^{99m} in a ratio of about 1:3.5 or in a ratio of about 1:3.

Optionally, the ratio between the amounts of the tracers is determined according to medical information pertaining to the administered patient. Optionally, the medical information is provided as described above.

Optionally, the ratio between the amounts of the tracers and/or the time of administering each tracer is determined according to respective pharmaceutical administration instructions. The administration instructions may be communicated through a communication interface between a pharmacy, such as a radiopharmacy, and the medical imaging facility.

According to some embodiments of the present invention, the multiplexing imaging, which is performed with these RPs, is used in combination with CT. The CT provides anatomical information and allows observing tumors once they are already marked by the tracers.

Optionally, the tracers of each one of the aforementioned RPs are mixed and administered as a single dose. Optionally, the RP is divided to a plurality of doses which may be administered consecutively. In such embodiments, some or more of the aforementioned tracers may be administered separately. Optionally, these tracers are provided in separate containers or chambers. In such a manner, tracers may be administered separately, optionally consecutively in different periods, to achieve a higher absorption or concentration during a common imaging session, for example as mentioned above.

It should be noted that the aforementioned RPs may be administered to a patient as a mixture and/or provided as a kit of components which may be consecutively administered to the patient. The administering of the RPs allows a simultaneous imaging the pathologies which tagged by the respective markers.

It is expected that during the life of a patent maturing from this application many relevant systems and methods will be developed and the scope of the term medical imaging is intended to include all such new technologies a priori.

As used herein the term “about” refers to ±10%

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, an and the include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for managing a plurality of medical imaging procedures, comprising:
associating a machine readable tag with each of a plurality of patients designated for a plurality of medical imaging procedures;
monitoring a progress of at least one of said plurality of patients in a respective said medical imaging procedure; and
managing at least one medical imaging resource for performing said plurality of medical imaging procedures according to said progress.

2. The method of claim 1, wherein said managing comprises adjusting an imaging scanning pattern according to said progress.

3. The method of claim 1, wherein said plurality of medical imaging procedures are nuclear medical imaging procedures, said monitoring comprises monitoring an order of a radiopharmaceutical preparation (RP) of at least one radioactive isotope and said managing being performed according to said at least one radioactive isotope.

4. The method of claim 3, further comprising receiving medical information pertaining to each said patient and providing an estimation of the decay profile of said at least one radioactive isotope in a respective said patient according to respective said medical information, said managing being performed according to said estimation.

5. A system for monitoring a plurality of imaged patients, comprising:
a resource interface for receiving a status data from at least one medical imaging resource each used in one of a plurality of stages of a imaging procedure;
a patient interface for automatically interfacing with a plurality of medical imaging procedure tags associated with a plurality of patients so as to receive, from each said medical imaging procedure tag, data indicative of the stage of said plurality of stages in which a respective said patient being in; and
a processing unit for allocating said at least one medical imaging resource to said plurality of patients according to said data.

6. The system of claim 5, wherein said processing unit is configured for monitoring a progress of said plurality of patients along said plurality of stages according to said data and generating an alert according to said progress.

7. The system of claim 6, further comprising a communication unit for forwarding said alert to at least one of said plurality of medical imaging procedure tags.

8. The system of claim 5, wherein said imaging procedure is a nuclear medical imaging procedure and one of said plurality of stages being a radiopharmaceutical preparation (RP) injection having a decay profile, said processing unit being configured to for timing said allocation according to said decay profile.

9. A method for reporting a progress of a plurality of medical imaging procedures, comprising:
associating a machine readable tag with each of a plurality of patients designated for a plurality of medical imaging procedures;
automatically monitoring a progress of at least one of said plurality of patients in a respective said medical imaging procedure; and
outputting a report indicative of said progress.

10. The method of claim 9, further comprising associating a machine readable tag with each of a plurality of radiopharmaceutical preparation (RP) containers designated for said plurality of medical imaging tagged procedures, said monitoring being performed according so a geographic location of said plurality of RP containers.

11. The method of claim 9, wherein said outputting comprises forwarding said report as an alert to a system operator.

12. A method for preparing at least one pharmaceutical preparation, comprising:
setting a scheduling for a nuclear medicine imaging process of a patient at a clinical center;
establishing a connection between said clinical center and at least one pharmacy; and
sending said scheduling and medical information pertaining to said patient to at least one pharmacy via said connection;
wherein said sending allows said at least one pharmacy to generate a pharmaceutical preparation for said nuclear medicine imaging process according to said medical information and said scheduling.

13. The method of claim 12, wherein said sending comprises updating at least one of said scheduling and said medical information, said pharmaceutical preparation being generated according to said updating.

14. The method of claim 12, wherein said sending comprises sending pricing information so as to allow said at least one pharmacy to prepare said pharmaceutical preparation according to said pricing information.

15. The method of claim 12, wherein said pharmaceutical preparation comprises a mixture of a plurality of isotopic tracers, wherein a ratio between said plurality of isotopic tracers is determined according to at least one of said scheduling and said medical information.

16. The method of claim 12, further comprising receiving, via said connection, a notification indicative of at least one of a decline to generate said pharmaceutical preparation and a confirmation for a generation of said pharmaceutical preparation.

17. The method of claim 12, further comprising receiving, at said clinical center, said pharmaceutical preparation and monitoring a usage of said pharmaceutical preparation according to said scheduling.

18. A method for preparing at least one radiopharmaceutical preparation, comprising:
providing a radiopharmaceutical preparation (RP) having at least one radioactive isotope for a nuclear medicine imaging process for a patient;
providing medical information related to said patient;
automatically calculating a concentration-time profile of said RP in said patient according to said medical information and said at least one radioactive isotope; and
automatically scheduling an allocation of at least one medical imaging resource for performing at least one stage of said nuclear medicine imaging process according to said concentration-time profile.

19. The method of claim 18, further comprising adjusting at least one imaging session of said medical imaging resource according to said concentration-time profile.

20. The method of claim 18, wherein said providing comprises providing a plurality of RPs for a plurality of medical imaging acquisition sessions performed during said nuclear medicine imaging process, said calculating and said scheduling being performed for each said RP.

21-66. (canceled)

67. The method of claim 18, wherein said RP comprises at least one dose consisting of at least two of the following components:
Sestamibi Tc^{99m};
Tl201;
Teboroxime Tc^{99m};
Thymidine I¹²³; and
PK-11195 and at least one of I¹²³ and In¹¹¹.

68. The method of claim 18, wherein said RP comprises a plurality of doses each having a different component.

69. The method of claim 18, wherein said RP comprises a member from a group consisting of a contrast agent, a stress agent and a pharmaceutical modulating at least one target tissue property.

70. The method of claim 18, wherein said RP comprises at least one dose consisting of at least two of the following components:
Sestamibi Tc^{99m};
Arcitumomab carcinoembryonic antigen (CEA) Tc^{99m};
Tl201;
Teboroxime Tc^{99m};
Avastin In¹¹¹;
Thymidine I¹²³; and
PK-11195 and at least one of +I¹²³ and In¹¹¹.

71. The method of claim 18, wherein said RP comprises at least one dose consisting of at least two of the following components:
Sestamibi Tc^{99m};
Tl201;
Teboroxime Tc^{99m};
Herceptin I¹²³; and
PK-11195 and at least one of I¹²³ and In¹¹¹.

72. The method of claim 18, wherein said RP comprises at least one dose consisting of the following components:
Sestamibi Tc^{99m}; and
J-591 labeled with In¹¹¹.

73. The method of claim 18, wherein said RP comprises at least one dose consisting of at least two of the following components:
Rituxan+In¹¹¹;
Thymidine I¹²³;
Ga⁶⁷;
Sestamibi Tc^{99m}; and
Teboroxime Tc^{99m}.

74. The method of claim 18, wherein said RP comprises at least one dose consisting of a member of a group consisting of Thallium 201 and Sestamibi Tc^{99m} in a ratio of about 1:3.5 and Thallium 201 and Sestamibi Tc^{99m} in a ratio of about 1:3.
